(19) United States
(12) Patent Application Publication
(10) Pub. No.: US 2007/0038897 A1
(43) Pub. Date: Feb. 15, 2007

(54) Method and system for delivering a software product from a central computer to a target computer via a computer network

(76) Inventor: Theresia Lainer, Seligenporten (DE)

Correspondence Address: BRINKS HOFER GILSON & LIONE, P.O. BOX 10395, CHICAGO, IL, 60610, US

(21) Appl. No.: 11/235,748

(22) Filed: Sep. 27, 2005

Related U.S. Application Data
(60) Provisional application No. 60/707,997, filed on Aug. 12, 2005.

(51) Int. Cl. G06F 11/00

(52) U.S. Cl. 714/38

(57) ABSTRACT

A method and a system for delivering a software product from a central computer to a target computer via a computer network are disclosed. In a first method step, a software product package of the software product is transmitted from the central computer to the target computer via the computer network, and, in a second method step, the software product is installed on the target computer based on a control signal sent from the central computer to the target computer via the computer network. The system comprises modules of the central computer to transmit the software product package to the target computer, to send the control signal to the target computer. The system comprises modules of the target computer to receive the software product package and to install the software product, from the software product package, based on the control signal.

### RELATED APPLICATIONS

This present document claims the benefit of the filing date pursuant to 35 U.S.C. §119(e) of U.S. Provisional Patent Application No. 60/707,997, filed on Aug. 12, 2005, herein incorporated by reference.

### FIELD

The present embodiments relate, in general, to the field of delivering software products and, in particular, to the delivery of software products via a computer network.

### BACKGROUND

Software products are needed to operate and use computers and devices which are similar to computers. A software product may, for example, be distributed by storing the software product on a data storage medium and delivering the data storage medium to a user. This user installs the software product on the computer from the data storage medium. This kind of delivery of the respective software product presupposes that the data storage medium will be transported from the supplier of the software product to the user of the latter and is therefore time-consuming.

On account of shortened development times and frequent updates of software products, it is expedient to select faster forms of delivery of software products. Software products are therefore frequently delivered via a computer network, for example the Internet. In such delivery, a software product package of the software product is provided on a central computer, for example a server on the Internet. This software product package is transmitted, via the computer network, to a target computer on which the software product is intended to be installed. The software product package is, for example, in the form of an executable computer file which can be used to install the software product on the target computer. The respective software product which can be installed using the software product package may be only one component of a more comprehensive software product. The software product which is to be installed may constitute an update for a software product that already exists.

One concern in a system for delivering a software product via a computer network is to transmit data which are relevant to the respective software product to the respective target computer in the form of a software product package and to install the respective software product on the target computer. Transmitting via the computer network allows a large number of target computers to be supplied with the respective software product within a relatively short period of time.

After the software product package has been transmitted to the target computer, the respective software product can be installed, for example, during ongoing operation of the target computer. This installation is started either automatically or via a user input. However, installation of the software product is generally not performed during ongoing operation of the target computer or may result in errors. Provision is generally made for the software product to be installed when rebooting the target computer.

Various methods for implementing certain parts of the delivery process described above have been proposed, and reference is made to some known methods below.

U.S. Patent Publication No. 2003/0046681 A1, by BARTUREN et al., entitled “Integrated system and method for the management of a complete end-to-end software delivery process” discloses a system and a method for managing a software product over its entire life cycle, from development to installation of the software product.

U.S. Pat. No. 6,067,582, by SMITH et al., entitled “System for installing information related to a software application to a remote computer over a network” discloses a system and a method for distributing, registering and acquiring software applications or other digital information via a network.

The patent documents mentioned above are hereby incorporated, in their entirety, by reference.

Although a software product is typically tested for any errors before being delivered, the software product may be defective or may not be installed on the respective target computer without errors. Many errors which cannot be excluded from the outset may occur during extensive installation on many (potentially very different) target computers. If an error has already been noticed before delivery, the error can still be corrected before delivery. If a defective software product has already been delivered and installed on the respective target computer, the installed software package has to be subsequently removed. This software package is removed, for example, by manually uninstalling it or by delivering a software product whose errors have been removed and which replaces the defective software product. Manually removing the software product from the target computer may require the cooperation of the respective user and is therefore time-consuming and labor-intensive. Replacing the defective software product with the software product whose errors have been removed initially requires the error in the software product to be found and removed and the software product whose errors have been removed to be prepared for delivery. This replacement procedure is typically time-consuming.

### BRIEF SUMMARY

The present invention is defined by the appended claims. This description summarizes some aspects of the present embodiments and should not be used to limit the claims.

The known methods and systems may not be capable of reversing the delivery of a defective software package in real time. No system or method which supports reacting flexibly to the discovery of an error in the software product during delivery of the respective software product is known.

Accordingly, there is a need to be able to influence the delivery of a software product via a computer network in real time and in a flexible manner, and moreover to reverse the delivery of a software product in real time, when the delivery has already been carried out.

One aspect is a method for delivering a software product from a central computer to a target computer via a computer network. The method includes the following acts of: transmitting a software product package of the software product from the central computer to the target computer via the computer network, and installing the software product, from the software product package, on the target computer in a manner dependent on a control signal sent from the central computer to the target computer via the computer network.

Another aspect is a system for delivering a software product from a central computer to a target computer via a computer network. The system includes a transmission module or unit, integrated in the central computer, to transmit a software product package of the software product from the central computer to the target computer via the computer network, a reception module, integrated in the target computer, to receive the software product package, a control module, integrated in the central computer, to send a control signal to the target computer via the computer network, and an installation module, integrated in the target computer, to install the software product, from the software product package, on the target computer based on the control signal.

The term “computer” is intended to have the widest applicable meaning and to include not only a personal computer, server or workstation but also a device component which is similar to a computer and is integrated in another device, for example in devices for medical imaging. In the last-mentioned alternative, the software product may be, for example, firmware for the device or device component.

The abovementioned modules may be implemented, for example, as software in the central computer and in the target computer. However, the abovementioned modules may also be in the form of hardware components. The above mentioned computer network may be, for example, the Internet, a local area network (LAN), a wireless LAN or a wide area network (WAN).

The control signal may be based on a network protocol provided for the respective computer network. A control signal which is based on a user-defined network protocol may also be used. Moreover, the control signal may be sent in the form of a message within a communication network, for example an “instant messenger” network or an email network.

In one exemplary embodiment, a beginning of installation of the software product is avoided, cancelled or prevented if the control signal is sent in the form of an abort signal before installation begins.

In another exemplary embodiment, a continuation of installation of the software product is aborted if the control signal is sent in the form of the abort signal after installation has begun. In another embodiment, the state of the target computer before installation began is restored after installation has been aborted. This is implemented, for example, by uninstalling those parts of the software product which have already been installed or by reconstructing a restoration point or state that was set before installation.

In another embodiment, depending on the respective progress of delivery, the beginning of installation is prevented or the continuation of installation is aborted if the control signal is sent in the form of the abort signal. In still another embodiment, installation is reversed if the control signal is sent in the form of the abort signal after installation has ended. In this situation, installation can be reversed either by uninstalling the software product or by reconstructing a restoration point that was stored before installation.

In another embodiment, provision is made for installation to be begun or started only when the control signal is sent in the form of a continuation signal. After the abort signal has been sent after installation has ended, the state of the target computer before installation began can be restored, for example via uninstallation or by requesting a restoration point.

The abovementioned embodiments relate to the method and also apply analogously to the system.

The features and advantages of embodiments are explained in more detail using the following detailed description of exemplary embodiments and with reference to the attached drawings.

### BRIEF DESCRIPTION OF THE DRAWINGS

FIG. 1 diagrammatically shows a time profile of delivery of a software product to a target computer, in which the installation of the software product is prevented via an abort signal sent before installation begins;

FIG. 2 shows a time profile as shown in FIG. 1, in which the installation of the software product on the target computer is aborted due to an abort signal sent during installation;

FIG. 3 shows a time profile as shown in FIG. 2, in which the installation of the software product on the target computer is reversed due to the abort signal sent after installation; and

FIG. 4 shows a central computer and a target computer which are connected to one another via a computer network so that the software product can be delivered from the central computer to the target computer via the compute network.

Similar parts and elements are identified by the same reference numerals or symbols in all the drawings.

### DETAILED DESCRIPTION OF THE DRAWINGS

The above, as well as other, advantages of the present invention will become readily apparent to those skilled in the art from the following detailed description of preferred embodiments when considered in the light of the accompanying drawings.

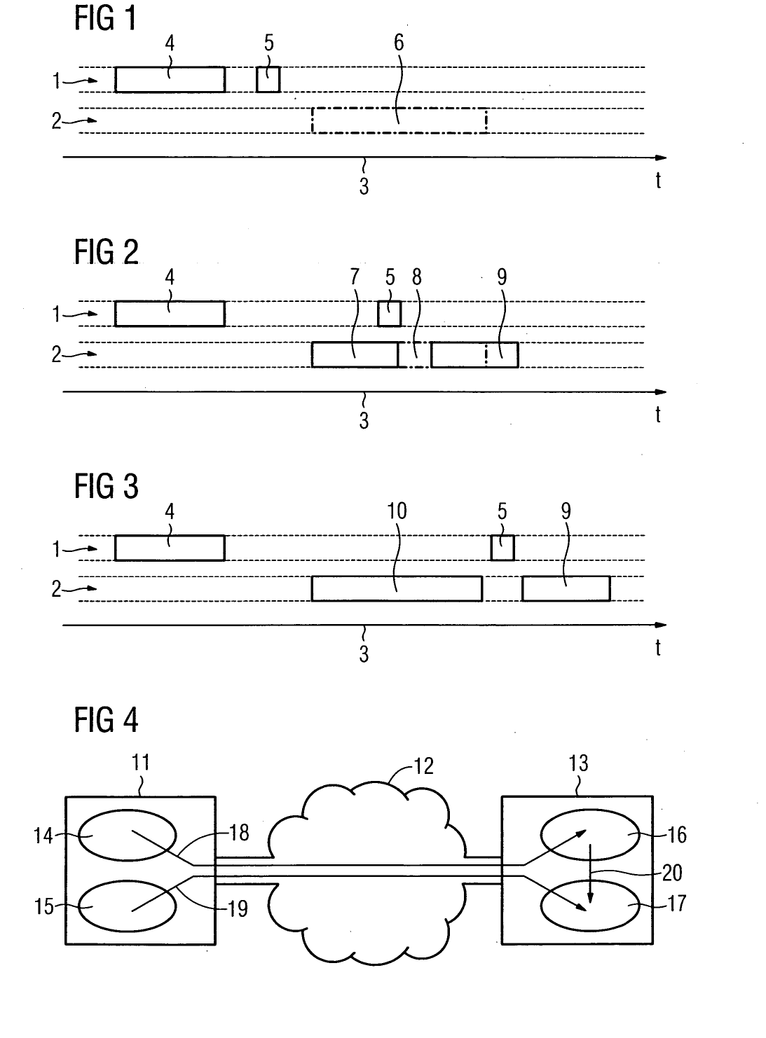

FIGS. 1 to 3 each show the delivery of a software product with the delivery being controlled via a control signal in the form of an abort signal.

The software product delivery can be controlled in a flexible manner, inter alia, while a software product is being delivered. As this control can be effected or implemented as early as during delivery of the software product, the delivery of the software product can be influenced or altered in the event of errors being discovered. Alternatively, the type of delivery or the software product may be changed during delivery. The original software product may also be expanded.

FIG. 1 shows, in a first row 1, data transmission from a central computer to a target computer and, in a second row 2, the respective sequences of events in the target computer, each in a chronological order from left to right. The chronological profile is indicated using a time axis 3.

The software product package of the software product is assembled and buffer-stored for delivery in the central computer. Provision is made for the software product to be delivered to a multiplicity of target computers, but only one target computer being may be picked out or chosen, for example. The software product may be delivered, for example, in accordance with a predefined delivery plan on the part of the central computer or via an enquiry from the target computer to the central computer via the computer network.

The software product package is initially transmitted from the central computer to the target computer via the computer network. In the first row 1, act 4 indicates transmission. The software product may be installed, from the software product package, on the target computer at a later point in time without further control by the central computer. In the second row 2, act 6 indicates the intended installation of the software product. Installation may be effected or implemented not only at a predefined point in time during ongoing operation of the target computer but also only after the target computer has been rebooted.

In this exemplary embodiment, after the software product package has been transmitted but before installation of the software product has begun, the central computer sends a control signal in the form of an abort signal to the target computer via the computer network. In the first row 1, act 5 indicates the sending of the abort signal. This abort signal prevents or cancels installation of the software package on the computer. In a relatively simple manner, the software product is not installed on the target computer, and the software product package can be removed from the target computer with relatively little complexity. As such, any errors in the software product do not appear on the respective target computer, and complicated subsequent uninstallation of the software product may not be needed.

If an error is discovered in the respective software product package, for example while the software product package is being transmitted, installation and removal of the software product can be avoided as illustrated in FIG. 1, so as to react flexibly to any errors or changes as early as during delivery of the software product.

Alternatively, installation may be begun only when a control signal is sent in the form of a continuation signal. This continuation signal is sent, for example, only when no errors are discovered in the software product before the intended beginning of installation. Accordingly, either the central computer itself may send the continuation signal to the target computer, or the target computer may send an enquiry to the central computer via the computer network before installation begins, and the central computer may send the continuation signal to the target computer only in response to this enquiry. As discussed above, the target computer having the software product package that has already been transmitted could, for example, during rebooting, sets up a connection to the central computer via the computer network in order to send the abovementioned enquiry to the central computer. The boot-up operation of the target computer and installation of the software product are delayed until the central computer sends the continuation signal to the target computer. This enquiry before installation begins prevents a potentially defective software product being installed and avoids subsequent removal of this software product.

FIG. 2 shows diagrammatically a time profile as in FIG. 1, but, in contrast to FIG. 1, the abort signal is not transmitted from the central computer to the target computer until the installation of the software product is in progress. In the second row 2, act 7 is used to represent the first part of the installation that has already begun. Complete installation of the software product may also comprise the second part of installation, which is indicated in FIG. 2 using act 8. This embodiment allows or enables a cancellation or prevention of the completion of the installation that is still in progress. Negative effects of any errors in the software product on the target computer may be avoided. Like the embodiment shown in FIG. 1, this embodiment also allows a relatively fast response to potential errors in the software product in an uncomplicated manner.

In the second row 2, act 9 is used to indicate the restoration of the state of the target computer before installation of the software product began. In this exemplary embodiment, the restoration is effected or implemented by uninstalling that part of the software product which has already been installed. Alternatively, the state of the target computer before installation began may be restored by requesting a restoration point that was set before installation. This removes parts of the software product which may have already been installed and may be defective from the respective target computer.

Alternatively, installation may be completed after the abort signal has been transmitted at act 5 and for the software product to be removed from the target computer after installation has ended.

FIG. 3 shows diagrammatically a time profile as in FIG. 2. In contrast to FIG. 2, the abort signal is not sent from the central computer to the target computer until after installation of the software product has ended. Act 10 is used to indicate installation of the software product and, as in FIGS. 1 and 2, act 5 is used to indicate transmission of the abort signal. In this exemplary embodiment, the state of the target computer before installation began is restored on the target computer by uninstalling at act 9 the software product once the target computer receives the abort signal that has been sent by the central computer. The abort signal can thus be used to reverse installation in a relatively simple manner and in real time.

Potentially, at least two of the embodiments which are illustrated in FIGS. 1 to 3 and have been described above can be combined. Combining all three embodiments enables the abort signal to be sent to the target computer at any determined point in time—both before, during and after installation, see acts 6, 7 and 10, of the software product.

In comparison with previously known methods, for example subsequent manual uninstallation of the software product or correction of the error in the software product and delivery of the corrected software product, the above-described embodiments of the present method are comparatively uncomplicated and timesaving. The same comparatively uncomplicated and timesaving are also applicable to corresponding embodiments of the system.

In order to deliver the software product to the target computer, a software distribution tool may be installed, for example, on the central computer. This software distribution tool is used both to transmit the software product package to the target computer and to send the control signal to the target computer. By way of example, an operator interface in which delivery of the software product and of other software products can be planned may be provided in the software distribution tool. The delivery orders for the various software products may be listed in the operator interface. An operator symbol for sending the abovementioned control signal may be arranged beside the respective delivery order in the list. Such an operator interface or a comparable operator interface easily enables controlled delivery of the respective software product.

The above-described delivery to a target computer also includes the option of delivering to other target computers.

FIG. 4 shows a central computer 11 and a target computer 13 which are connected to one another via a computer network 12. Modules which are described in more detail below are integrated in the two computers as computer readable media having instructions for operating the modules. In this exemplary embodiment, the modules are installed on the respective computer in the form of software. Installed on the central computer 11 is a transmission module 14 which can transmit a software product package—which has been buffer-stored on a data storage medium of the central computer 11 to be ready for transmission—of a respective software product from the central computer 11 to the target computer 13 via the computer network. The arrow 18 indicates this transmission of the software product package. The software product package that has been transmitted is received by the reception module 16 of the target computer 13. Also installed on the central computer 11 is the control module 15 which enables sending a control signal to the target computer 13 via the computer network 12. The arrow 19 indicates transmission of the control signal.

Installed on the target computer 13 is the installation module 17 which installs the software product, from the software product package that has been transmitted, on the target computer 13 in a manner dependent on the control signal. In this exemplary embodiment, the installation module 17 receives the software product package directly from the reception module 16 via a data link 20. The reception module 16 and the installation module 17 may be integrated to form one module. Besides the illustrated target computer 13 other target computers may be connected to the central computer 11 via the computer network 12. The software product can also be delivered from the central computer 11 to the other target computers via the computer network 12.

The software product is delivered, for example, in accordance with one of the time profiles illustrated in FIGS. 1 to 3. The embodiments described in FIGS. 1 to 3 and their advantages can be applied to the situation or arrangement illustrated in FIG. 4.

1. A method for delivering a software product from a central computer to a target computer via a computer network, the method comprising:
receiving a software product package of the software product from the central computer at the target computer via the computer network; and
installing the software product, from the software product package, on the target computer based on a control signal sent from the central computer to the target computer via the computer network.

2. The method as claimed in claim 1, further comprising:
canceling a beginning of installation of the software product if the control signal comprises an abort signal received before installation begins.

3. The method as claimed in claim 1, further comprising:
aborting a continuation of installation of the software product if the control signal comprises an abort signal after installation has begun.

4. The method as claimed in claim 3, further comprising:
restoring a state of the target computer before installation begins.

5. The method as claimed in claim 1, further comprising:
preventing a beginning of installation or aborting a continuation of installation if the control signal comprises an abort signal.

6. The method as claimed in claim 5, further comprising:
restoring a state of the target computer before installation began.

7. The method as claimed in claim 1, further comprising:
starting installation when the control signal comprises a continuation signal.

8. The method as claimed in claim 1, further comprising:
reversing installation if the control signal comprises an abort signal after installation has ended.

9. The method as claimed in claim 8, further comprising:
restoring a state of the target computer before installation began.

10. A method for delivering a software product from a central computer to a target computer via a computer network, the method comprising:
receiving a software product package of the software product from the central computer at the target computer via the computer network; and
installing the software product on the target computer as a function of an abort signal sent from the central computer to the target computer via the computer network, a beginning of installation being prevented or a continuation of installation being aborted if the central computer sends the abort signal.

11. A method for delivering a software product from a central computer to a target computer via a computer network, the method comprising the following steps of:
receiving a software product package of the software product from the central computer at the target computer via the computer network; and
installing the software product on the target computer in response to a continuation signal, installation being begun only when the continuation signal is sent.

12. In a system for delivering a software product from a central computer to a target computer via a computer network, the system having computer readable media with instructions operable in a programmed processor, the computer readable media having instructions for:
a transmission module, in the central computer, to transmit a software product package of the software product from the central computer to the target computer via the computer network;
a reception module, in the target computer, to receive the software product package;
a control module, in the central computer, to send a control signal to the target computer via the computer network; and
an installation module, in the target computer, to install the software product on the target computer as a function of the control signal.

13. The system as claimed in claim 12, wherein the installation module aborts installation of the software product if the control signal comprising an abort signal is sent before installation has begun.

14. The system as claimed in claim 12, wherein the installation module aborts a continuation of installation of the software product if the control signal comprising an abort signal is sent after installation has begun.

15. The system as claimed in claim 14, wherein a state of the target computer before installation began is restored.

16. The system as claimed in claim 12, wherein the installation module aborts a beginning or a continuation of installation if the control signal comprises an abort signal.

17. The system as claimed in claim 16, wherein a state of the target computer before installation began is restored.

18. The system as claimed in claim 17, wherein installation is begun if the control signal comprises a continuation signal.

19. The system as claimed in claim 12, wherein the installation module reverses installation if the control signal comprises an abort signal after installation has ended.

20. The system as claimed in claim 19, wherein a state of the target computer before installation began is restored if the abort signal is sent after installation has ended.

21. A system for delivering a software product from a central computer to a target computer via a computer network, the system comprising:
the central computer comprising a transmission module to transmit a software product package of the software product from the central computer to the target computer via the computer network;
the target computer comprising a reception module to receive the software product package;
the central computer comprising a control module to send a control signal comprising an abort signal, to the target computer via the computer network; and
the target computer comprising an installation module to install the software product on the target computer based on the abort signal, the installation module prevents a beginning of installation or aborts a continuation of installation if the abort signal is sent.

22. A system for delivering a software product from a central computer to a target computer via a computer network, the system comprising:
the central computer comprising a transmission module to transmit a software product package of the software product from the central computer to the target computer via the computer network;
the target computer comprising a reception module to receive the software product package;
the central computer comprising a control module to send a control signal comprising a continuation signal, to the target computer via the computer network; and
the target computer comprising an installation module to install the software product on the target computer based on the continuation signal, installation beginning only if the continuation signal is sent.
